(19) United States
(12) Patent Application Publication
(10) Pub. No.: US 2004/0233659 A1
(43) Pub. Date: Nov. 25, 2004

(54) Keyboard having illumination device

(76) Inventor: Guo An Chen, Hsin Chuang City (TW)

Correspondence Address: Guo An Chen, Hsin Chuang, P.O. Box 4-67, Taipei, 242, TW

(21) Appl. No.: 10/445,150

(22) Filed: May 23, 2003

(51) Int. Cl. F21V 33/00

(52) U.S. Cl. 362/85; 362/257

(57) ABSTRACT

A keyboard includes a number of buttons for being actuated by users, and includes a space formed between the buttons, and includes an electric circuit. One or more illuminating members and one or more optical elements are disposed on the space of the keyboard and disposed close to each other. The illuminating member is coupled to the electric circuit of the keyboard and to be energized to generate light through the optical element, and to light the buttons of the keyboard. The illuminating members are not required to be electrically coupled to the other electric power source separately.

### BACKGROUND OF THE INVENTION

1. Field of the Invention

The present invention relates to a keyboard, and more particularly to a keyboard having a light or illumination device for lighting or illuminating the keyboard.

2. Description of the Prior Art

Various kinds of typical keyboards have been developed and provided to be coupled to computer facilities, comprise a number of buttons provided thereon and for being depressed or stricken by the users, in order to input or key in various information or data into the computer facilities.

However, the buttons of the keyboards may not be easily or clearly seen in dark environments, such that additional light devices or members are further required to be provided and disposed above the keyboards, in order to light or illuminate the buttons of the keyboards.

It will be difficult to prepare and install the additional light devices or members, and to dispose the light devices or members above the buttons of the keyboards, and to couple the light devices or members to the electric power sources.

In addition, when the additional light devices or members are disposed beside or above the keyboards, the light devices or members may have a good chance to be hit or stricken by the users inadvertently, and the users may also have a good chance to be hurt by the light devices or members inadvertently.

The present invention has arisen to mitigate and/or obviate the afore-described disadvantages of the conventional keyboards.

### SUMMARY OF THE INVENTION

The primary objective of the present invention is to provide a keyboard including a light or illumination device provided therein for lighting or illuminating the buttons of the keyboards, and for allowing the buttons of the keyboards to be easily depressed or stricken by the users.

In accordance with one aspect of the invention, there is provided a keyboard comprising a keyboard body including a plurality of buttons provided thereon for being actuated by users, and including a space formed therein and defined between the buttons, and including an electric circuit provided therein, and at least one illuminating member and at least one optical element disposed on the space of the keyboard body, and disposed close to each other. The illuminating member is coupled to the electric circuit of the keyboard body, and to be energized to generate light through the optical element, and to light the buttons of the keyboard body. The illuminating members are not required to be electrically coupled to the other electric power source separately.

The keyboard body includes at least one recess formed therein to receive the illuminating member and the optical element, and to stably retain the illuminating member and the optical element in the space of the keyboard body.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a keyboard in accordance with the present invention;

FIG. 2 is a front plan schematic view of the keyboard, illustrating the coupling of the light or illumination device to the electric circuit of the keyboard;

FIG. 3 is a plan schematic view of the light or illumination device for the keyboard;

FIG. 4 is a perspective view illustrating the other arrangement of the light or illumination device onto the keyboard;

FIG. 5 is a perspective view illustrating a mouse device having a light or illumination device in accordance with the present invention;

FIG. 6 is a perspective view illustrating a joy stick device having a light or illumination device in accordance with the present invention; and

FIG. 7 is a perspective view illustrating a calculator or a personal digital assistant or the like having a light or illumination device in accordance with the present invention.

### DETAILED DESCRIPTION OF THE PREFERRED EMBODIMENT

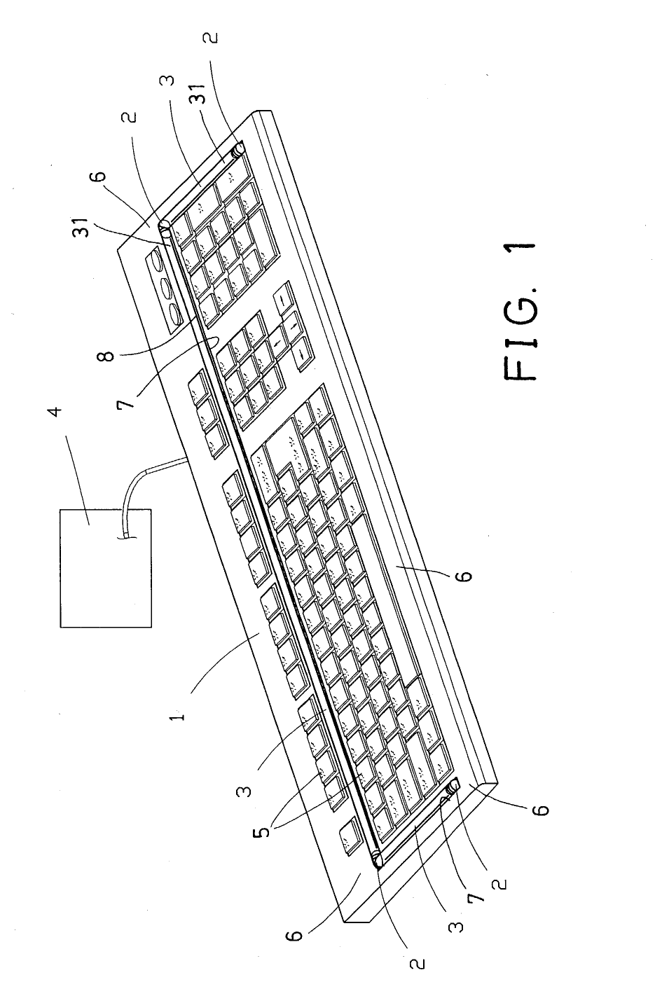

Referring to the drawings, and initially to FIGS. 1-3, a keyboard 1 in accordance with the present invention is also provided for being coupled to various computer facilities 4, and comprises a keyboard body 1 including a number of buttons 5 provided thereon and for being depressed or stricken or actuated by the users, in order to input various information or data into the computer facilities 4.

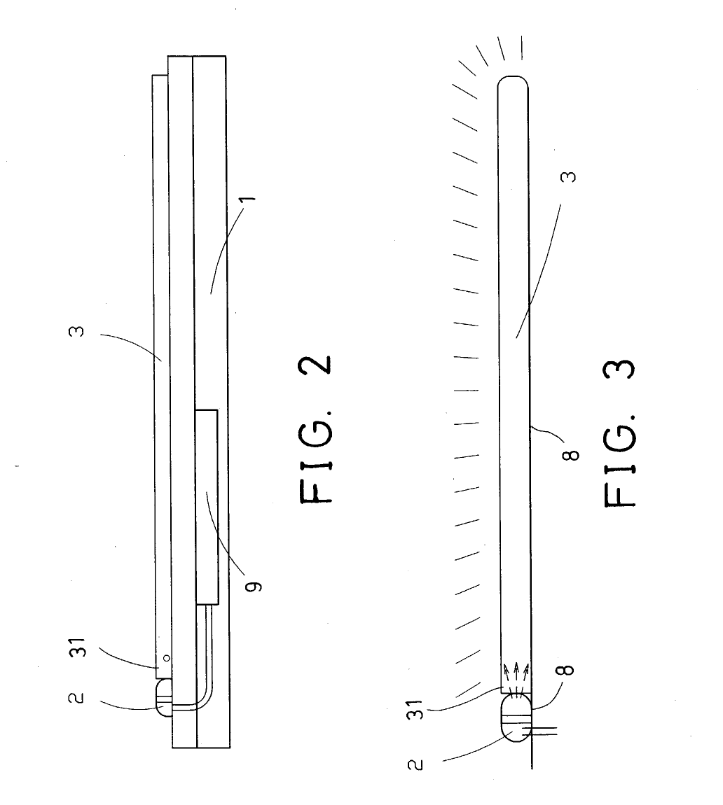

The keyboard body 1 further comprises a number of spaces 6 formed or defined or located between the buttons 5 without being used, and comprises a typical processor device or integrated circuit or control circuit 9 disposed therein (FIG. 2), for controlling the operation of the keyboard body 1. The above-identified configuration is typical for the keyboard body 1 and will not be described in further details.

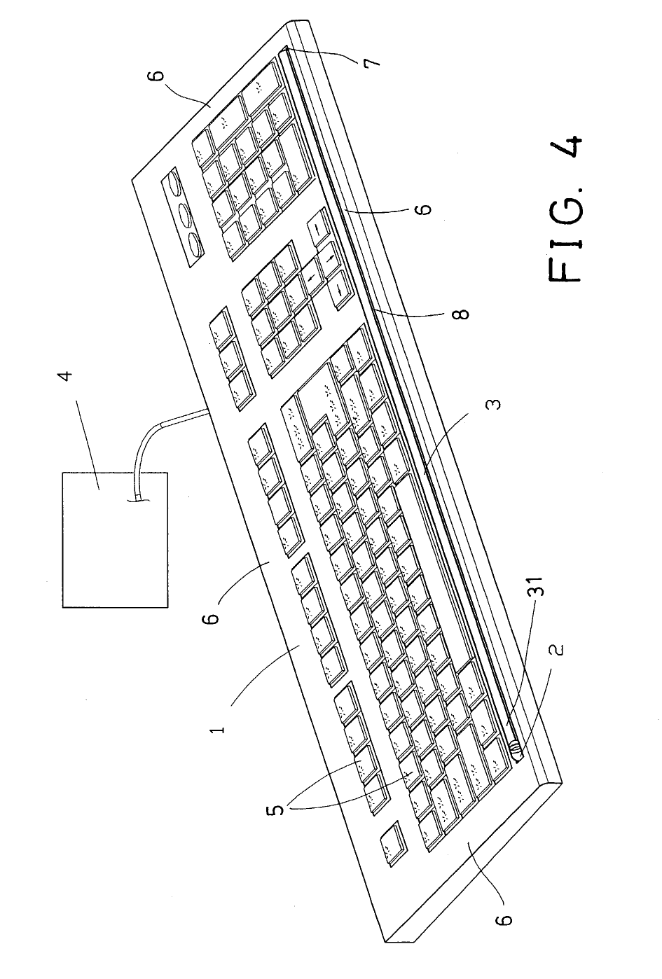

The keyboard in accordance with the present invention further includes one or more light members or illuminating members 2, such as light bulbs, light emitting diodes (LED), or the like, and one or more light transmittable or optical elements 3 disposed on the keyboard body 1, particularly disposed on or in the spaces 6 of the keyboard body 1, best shown in FIGS. 1 and 4.

For example, the optical elements 3 may be made of transparent or semi-transparent and/or flexible materials, such as plastic, acrylic, or other synthetic materials, that may receive and dissipate lights, best shown in FIG. 3. For example, the illuminating members 2 may be disposed in or located close to the ends 31 of the optical elements 3, to generate and emit the light through the optical elements 3, and then to allow the light to be emitted or transmitted out through the optical elements 3.

As shown in FIG. 2, the illuminating members 2 may be coupled to the processor device or integrated circuit or control circuit 9 of the keyboard body 1, and may thus be energized by the electric power source supplied to the processor device or integrated circuit or control circuit 9 of the keyboard body 1, such that the illuminating members 2 are not required to be electrically coupled to the other electric power source.

The illuminating members 2 and the optical elements 3 may be secured or attached onto the spaces 6 of the keyboard body 1 with fastener members 8, such as adhesive materials, hook-and-loop fastener members 8, etc.

The keyboard body 1 may include one or more recesses 7 formed therein to partially receive the illuminating members 2 and the optical elements 3, and to stably receive and retain the illuminating members 2 and the optical elements 3 in the spaces 6 of the keyboard body 1.

In operation, when the keyboard body 1 is coupled to the electric power source or when the keyboard body 1 is energized, the illuminating members 2 may also be energized by the processor device or integrated circuit or control circuit 9 of the keyboard body 1, such that the illuminating members 2 may generate and emit the light through the optical elements 3, and then to allow the light to be emitted or transmitted out through the optical elements 3, and to illuminate the buttons 5 of the keyboard body 1.

The illuminating members 2 are not required to be electrically coupled to the other electric power source separately.

In addition, the illuminating members 2 and the optical elements 3 may be easily secured or attached onto the spaces 6 of any of the typical keyboard bodies 1 that have already been purchased and used by the users.

As best shown in FIG. 1, one of the illuminating members 2 may be disposed between the ends of two or more optical elements 3, to generate and emit the light through the optical elements 3 simultaneously.

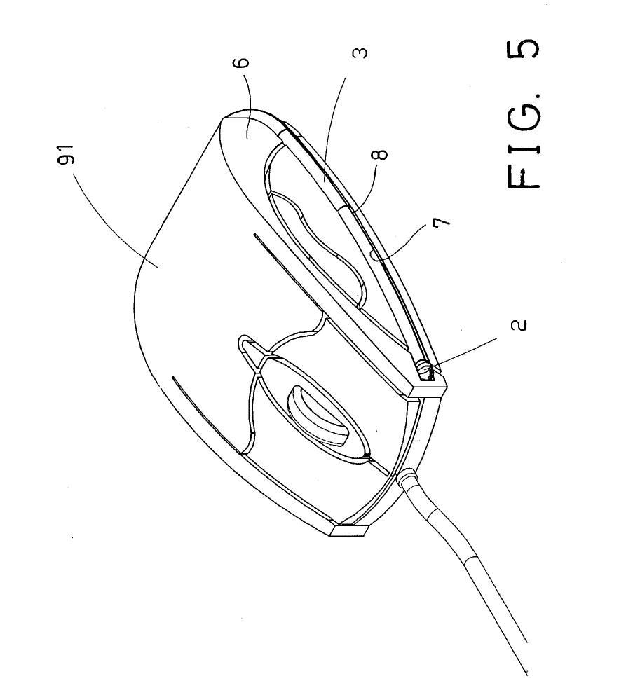

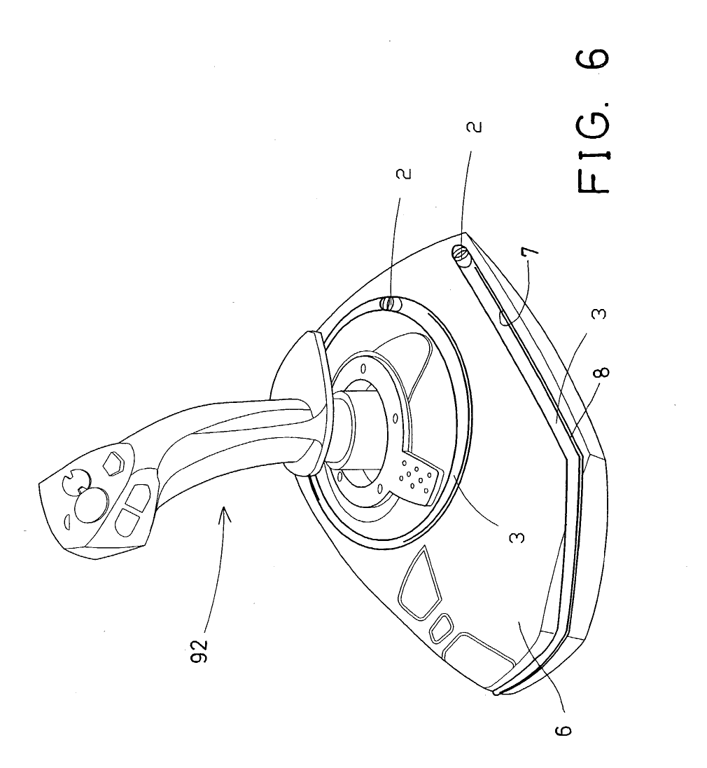

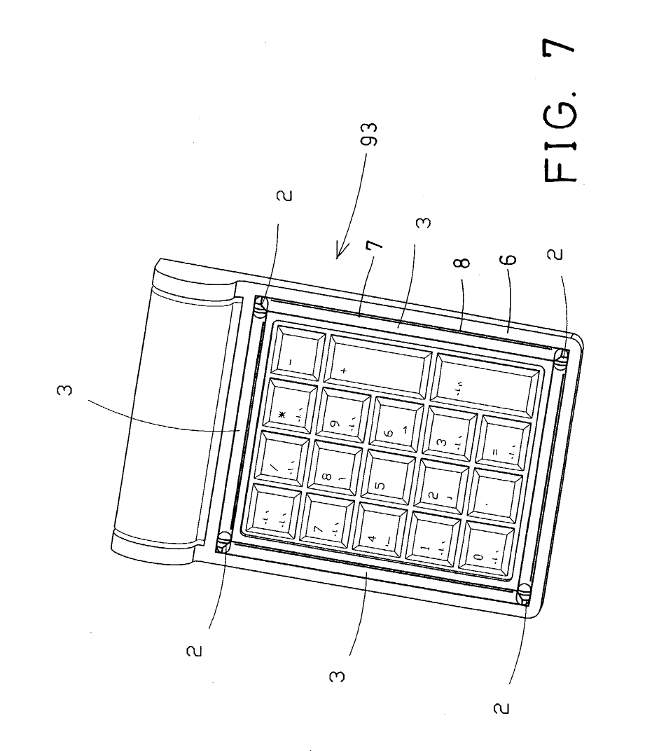

Similarly, as shown in FIGS. 5-7, the illuminating members 2 and the optical elements 3 may also be secured or attached onto the spaces 6 of the other typical peripheral facilities 91, 92, 93 for the computer facilities 4, such as the mouse device 91, the joy stick device 92, or the personal digital assistant (PDA) 93, with the fastener members 8 or the like.

The typical peripheral facilities 91, 92, 93 for the computer facilities 4, such as the mouse device 91, the joy stick device 92, or the personal digital assistant (PDA) 93, may also include one or more recesses 7 formed therein to partially receive the illuminating members 2 and the optical elements 3, and to stably receive and retain the illuminating members 2 and the optical elements 3 in the spaces 6 of the keyboard body 1.

Accordingly, the keyboard in accordance with the present invention includes a light or illumination device provided therein for lighting or illuminating the buttons of the keyboards, and for allowing the buttons of the keyboards to be easily depressed or stricken by the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A keyboard comprising:
a keyboard body including a plurality of buttons provided thereon for being actuated by users, and including a space formed therein and defined between said buttons, and including an electric circuit provided therein, and
at least one illuminating member and at least one optical element disposed on said space of said keyboard body, and disposed close to each other,
said at least one illuminating member being coupled to said electric circuit of said keyboard body, and to be energized to generate light through said at least one optical element, and to light said buttons of said keyboard body.

2. The keyboard as claimed in claim 1, wherein said keyboard body includes at least one recess formed therein to receive said at least one illuminating member and said at least one optical element, and to stably retain said at least one illuminating member and said at least one optical element in said space of said keyboard body.
